(19) United States
(12) Patent Application Publication
(10) Pub. No.: US 2011/0190228 A1
(43) Pub. Date: Aug. 4, 2011

(54) SANITISING COMPOSITIONS

(76) Inventors: Peter Finan, Haworth Yorkshire (GB); John Michael Story, Doncaster Yorkshire (GB)

(21) Appl. No.: 12/735,723

(22) PCT Filed: Feb. 26, 2009
(86) PCT No.: PCT/GB2009/050193

§ 371 Date: Sep. 27, 2010

(30) Foreign Application Priority Data
Feb. 26, 2008 (GB) 0803473.8

(51) Int. Cl. A01N 43/16; A01P 1/00

(52) U.S. Cl. 514/27; 514/456

(57) ABSTRACT

The present invention relates to a sanitising composition, particularly to a sanitising composition for combating undesired microorganisms, especially those present on food products such as salads, poultry, cut fruit, and in hospital environments. There is provided a sanitising composition comprising at least one flavonoid, and at least one a surfactant, wherein the composition is acidic.

The present invention relates to sanitising compositions, particularly to sanitising compositions for combating undesired microorganisms, for example bacteria, moulds and yeasts, on surfaces, to decontaminate the surfaces or to reduce the populations of undesired microorganisms on the surfaces to a useful extent. The undesired microorganisms may be present on, for example food products such as salads, poultry, cut fruit and prepared vegetables; or on surfaces, fabrics, and implements in hospitals (without limitation, implements may include, for example, tools, implants, trays, sanitary products, endoscopes and catheters).

There is a widespread need for improved sanitising compositions, particularly for washing fresh food produce, and for use in medical facilities. Such compositions need to be effective at sanitising under desired treatment conditions, suitably mild so as to not damage the produce or articles being treated, non-toxic in quantities likely to be ingested, and easily manufactured from readily available components which are cleared for use by regulatory authorities.

Known sanitising compositions for washing such products as salads (lettuce, watercress, rocket, etc.) include either dilute sodium hypochlorite solution or flavonoid-based compositions, where such flavonoids are typically obtained from extracts of unripe citrus fruit. In the medical context many compositions have been used, including chlorine-based compositions, peroxy-based compositions and biguanide-based compositions.

A problem with known compositions is that they are only insufficiently effective at combating microorganisms including bacteria, and so do not sanitise the products to be treated, and they may contain harmful additives which may contaminate surfaces, for example of food if not rinsed off thoroughly.

It is thus an object of the present invention to provide a sanitising composition which solves at least one problem of the prior art.

According to a first aspect of the present invention there is provided a sanitising composition comprising at least one flavonoid, and at least one surfactant, wherein the composition is acidic.

Flavonoids are a sub-class of polyphenols, and may include flavonols (eg. quercetin), flavonons (eg. naringin, hesperidin) and/or flavons (eg. rutin).

The surfactant is preferably a surfactant which acts as an antimicrobial agent or acts as a promoter of enhanced antimicrobial action. That is, it may increase the antimicrobial action of the flavonoid. More than one such surfactant may be present in the sanitising composition.

A surfactant may comprise between 0.1 and 20 wt % of the total composition of the first aspect, and preferably comprises between 2 and 5 wt % (total weight of surfactants, when more then one is present).

One suitable surfactant is a betaine having the general structure:

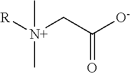

where R is a branched or unbranched alkyl group, optionally substituted, but preferably unsubstituted. Preferably R is an alkyl group having from 4 to 24 carbon atoms, preferably 8 to 20, most preferably 10 to 16. Lauryl betaine (LAB) is an especially preferred surfactant.

One suitable surfactant is a polyoxyethylene sorbitan fatty acid ester; commonly called a Polysorbate. Polyoxyethylene sorbitan fatty acid esters which may be used include the following:
Polyoxyethylene-(20)-sorbitan tristearate (common name Polysorbate 65)
Polyoxyethylene-(20)-sorbitan trioleate (common name Polysorbate 85)
Polyoxyethylene-(4)-sorbitan monolaurate (common name Polysorbate 21)
Polyoxyethylene-(20)-sorbitan monostearate (common name Polysorbate 60)
Polyoxyethylene-(4)-sorbitan monostearate (common name Polysorbate 61)
Polyoxyethylene-(20)-sorbitan monooleate (common name Polysorbate 80)
Polyoxyethylene-(5)-sorbitan monooleate (common name Polysorbate 81).
Polyoxyethylene-(20)-sorbitan tristearate is particularly preferred.

Other surfactants that could be used include those from the anionic, cationic, amphoteric and non-ionic classes.

The composition of the first aspect is preferably a liquid. Preferably the composition of the first aspect comprises a solvent.

Water is a preferred solvent of a composition of the first aspect. Water may suitably be present as a solvent in the composition of the first aspect in an amount of at least 50% of the weight of the composition of the first aspect; preferably at least 60%, and preferably up to 90% of the weight of the weight of the composition of the first aspect; preferably up to 80%. When water is present in a composition of the first aspect it is preferably softened or deionised water.

By describing the composition of the first aspect as acidic we mean that it may itself be acidic or may be a precursor of an acidic treatment composition.

The composition of the first aspect may be used as such but is preferably formulated as a concentrate composition which is diluted with water to form a treatment composition (described hereinafter as the second aspect of the invention). Preferably it is diluted with agitation or shearing. It is found that diluting it during its use or shortly before its use leads to the highest levels of efficacy, especially if there is agitation or shearing. A concentrate composition may be diluted, for example, by delivering the concentrate composition into a washing machine or automatic dishwasher; or by adding it to water in a bucket or sink; or by dosing it into a stream of water; or by spraying it onto a surface which is water-set or is to become water-wet; or by co-spraying it with water drawn form a separate source (using for example a double canister trigger spray device).

Preferably a composition of the first aspect is acidic to the extent that a 2 wt % aqueous solution of the composition has a pH less than 7, preferably less than 6, preferably less than 5. More preferably it is between 2 and 4, more preferably between 2 and 3, and most preferably between 2.1 and 2.5.

Preferably the composition of the first aspect, when supplied as a concentrate composition, and when diluted as a 2 wt % aqueous solution, gives a 10⁵ reduction in microbe colony count (log₁₀5). Preferably this applies to at least one of Pseudomonas aeruginosa, Escherichia coli, Staphylococcus aureus and Enterococcus hirae; preferably to at least two, preferably to at least three, and most preferably to all four. For the purpose of these definitions the test protocols of BS EN 1276:1997 may be referred to (see below). Such a composition without the surfactant, when diluted as a 2 wt % aqueous solution, may give a reduction of less than 10⁵ against the respective microorganism(s) that were combated to the extent of 10⁵, by the diluted composition of the first aspect.

Bactericidal activity is calculated as a reduction in the number of viable bacterial cells when a given strain of bacteria is added to a prepared sample of the composition. A detailed description of the protocols used for assessing bactericidal activity is available in British Standard BS EN 1276:1997 entitled “Chemical Disinfectants and Antiseptics—Quantitative Suspension Test for the Evaluation of Bactericidal Activity of Chemical Disinfectants and Antiseptics used in Food, Industrial, Domestic, and Institutional Areas—Test Method and Requirements (Phase 2, step 1)”. In brief, a composition with a bactericidal activity of at least 10⁵ means the composition produces at least a 10⁵ reduction in the number of viable bacterial cells belonging to a given reference strain (section 3.3 of BS EN 1276:1997). These protocols are further elaborated upon in the Examples which are set out below. The same protocol may be used for other microorganisms, such as moulds and yeasts.

A single flavonoid may be present, preferably selected from a flavonol (e.g. quercetin), a flavonon (e.g. naringin, hesperidin) and a flavon (e.g. rutin). The composition of the first aspect preferably comprises at least two flavonoids, preferably at least three flavonoids, preferably selected from a flavonol (e.g. quercetin) and a flavonon (e.g. naringin, hesperidin); and preferably also a flavon (e.g. rutin).

The flavonoid(s) is/are preferably obtained from citrus fruits.

Preferably the flavonoid(s) comprise(s) at least 0.001 wt % of the total composition of the first aspect, preferably at least 0.01 wt %, preferably at least 0.04 wt %. These figures denote total weight when a plurality of flavonoids are present.

Preferably the flavonoid(s) comprise(s) at most 10 wt % of the total composition of the first aspect, preferably at most 2 wt %, preferably at most 1 wt %, preferably at most 0.5%. These figures denote total weight when a plurality of flavonoids are present.

The acidity of the composition of the first aspect, particularly in its diluted form, is believed to be at least partially responsible for the activity of the flavonoids in respect of their antibacterial activity. The applicant believes that the equilibrium between quinone/phenolic forms of the flavonoids is shifted favourably under acidic conditions so as to give the form which exhibits the highest antibacterial activity.

The sanitising composition preferably comprises at least one organic acid, preferably selected from one or more of ascorbic acid, citric acid, lactic acid and malic acid. Preferably the pH of the composition is kept within the desired range through the addition of lactic acid, most preferably L(+) lactic acid.

The organic acid(s) preferably comprise(s) at least 3 wt % and at most 25 wt % of the total composition of the first aspect.

According to a second aspect of the present invention there is provided a ready-to-use treatment composition (hereinafter called a treatment composition) comprising water, at least one flavonoid; and at least one a surfactant; wherein the treatment composition is acidic. The treatment composition may be produced by mixing a composition according to the first aspect with a diluent.

Preferably the composition of the first aspect supplies up to 5 wt % of the treatment composition. More preferably the composition of the first aspect comprises up to 2 wt % of the treatment composition, for example up to 1 wt % of the treatment composition. In an alternative definition it may be stated that there may suitably be 1 part of the composition of the first aspect to 10-200 parts, preferably 20-100 parts, preferably 40-60 parts, water (wt:wt). Proportions stated above in relation to the components of the composition of the first aspect may be scaled down in accordance with the dilution definitions just given. For example it was stated that the flavonoid(s) may be present in the composition of the first aspect in an amount from 0.001 to 10 wt %. This means that the proportion of flavonoid(s) in the diluted treatment composition could in its broadest definition be from 5×10⁻⁶ wt % up to 1 wt %.

The diluent is preferably water. When the diluent is water it is desirable to use the treatment composition of the second aspect within 8 hours of dilution, preferably within 4 hours.

The pH of the treatment composition as used is preferably acidic, preferably less than pH 6, preferably less than pH 5, preferably between 2 and 4, most preferably between pH 2 and 3. As stated above, a treatment composition formed with 2 wt % aqueous solution of a concentrate composition of the first aspect preferably has a pH less than 7, preferably less than 6, preferably less than 5. More preferably it is between 2 and 4, more preferably between 2 and 3, and most preferably between 2.1 and 2.6.

According to a third aspect of the present invention there is provided a method of manufacturing the composition of the first aspect, comprising:
a) acidifying the solvent
b) blending the surfactant(s) and the flavonoid(s) with a solvent; preferably with the flavonoid(s) being under acidic conditions throughout the method.

The solvent may preferably comprises water, preferably in an amount as defined above in relation to the first aspect.

Preferably the flavonoid is always under acidic conditions.

According to a fourth aspect of the present invention there is provided a method of manufacturing the treatment composition of the second aspect, comprising dissolving the composition of the first aspect in water.

According to a fifth aspect of the present invention there is provided a method of combating undesired microorganisms at a locus, comprising delivering the composition of the first or second aspect to the locus or the vicinity thereof. The locus may be upon the surface of food products in need of sanitising. The locus may be upon surfaces, fabrics, or implements in need of decontamination, such as those found in hospitals. The method may also effect cleaning and de-greasing, as well as combating microorganisms.

Bacteria to be combated may include Pseudomonas aeruginosa, Escherichia coli, Staphylococcus aureus, Enterococcus hirae, or mixtures thereof.

Bacteria to be combated may include Salmonella typhimurium, Lactobacillus brevis, Enterobacter cloacae, or mixtures thereof.

Bacteria to be combated may include Listeria monocytogenes, Bacillus cereus, Campylobacter Jejuni.

Bacteria to be combated may include Pseudomonas, S. Aureus, MRSA, Clostridia, C. difficile, or mixtures thereof. Such bacteria are of particular concern in medical environments, including doctors' surgeries, hospitals and care homes.

Yeasts and moulds to be combated may include Candida albicans and Aspergillus niger.

The composition of the first aspect, when diluted as a 2 wt % aqueous solution, preferably has antimicrobial activity (colony count reduction) against any of the organisms mentioned above of at least 10⁵; and preferably has antimicrobial activity of at least 10⁵ against each of Pseudomonas aeruginosa, Escherichia coli, Staphylococcus aureus and Enterococcus hirae; and preferably has antimicrobial activity of at least 10⁵ against all the organisms mentioned above.

Preferably the locus or vicinity thereof is substantially rinsed with a polar solvent, for example water, after delivery of the treatment composition thereto.

According to a sixth aspect of the present invention there is provided a sanitised food product comprising a food product that has been treated with a composition of the first or second aspect.

According to a seventh aspect of the present invention there is provided the use of a composition of the first or second aspect for washing food.

According to an eighth aspect of the present invention there is provided the use of a composition of the first or second aspect for decontaminating surfaces.

According to a ninth aspect of the present invention there is provided a use of a composition of the first or second aspect in a medical or care home facility.

According to a tenth aspect of the present invention there is provided a use of a composition of the first or second aspect in a method of cleaning. Cleaning may include hard surface cleaning (for example floors, tiles, sanitaryware, and worktops); and laundering. When used in laundering a composition of the first or second aspect may suitably be added into a washing machine at the rinse stage. When it is a composition of the first aspect it is preferably not diluted before use, but is diluted within the machine.

Any preferred feature of any aspect of the invention expressed herein is a feature of the invention as a whole and is to be regarded as preferred feature of any other aspect.

When amounts of components of a composition are expressed they denote the percentage weight of the stated component as a percentage of the total composition weight, unless otherwise stated.

The following examples are not limiting. They are given only by way of illustration of the practice of the invention.

### EXAMPLES

A number of compositions were prepared for comparative testing in accordance with the aforementioned BS EN 1276:1997 protocols, described in more detail below. Such comparative tests demonstrate the improvements in antibacterial efficacy as certain components are added to flavonoid-containing compositions in accordance with the present invention.

### Example 1

### Example 1a

### Concentrate Compositions

Variants of potential sanitising compositions were prepared for comparative purposes. The table below shows the relative quantities of ingredients in concentrate compositions for each of the variants.

Each variant was prepared by dissolving the acid components in water followed by the surfactant and finally the bioflavonoid(s).

TABLE 1

| Ingredient | A | B | C | D | E | F | G | H |
|---|---|---|---|---|---|---|---|---|
| Softened Water | 93.5% | 90.0% | 88.0% | 64.5% | 67.0% | 68.0% | 70.4% | 81.0% |
| Citric Acid | 0.0% | 0.0% | 0.0% | 5.0% | 5.0% | 5.0% | 5.0% | 5.0% |
| Malic Acid | 0.0% | 0.0% | 0.0% | 10.0% | 10.0% | 10.0% | 10.0% | 10.0% |
| Lactic Acid | 0.0% | 0.0% | 0.0% | 4.0% | 4.0% | 4.0% | 4.0% | 4.0% |
| Mixed Bioflavonoids | 6.5% | 0.0% | 2.0% | 6.5% | 4.0% | 2.0% | 0.0% | 0.0% |
| Betaine composition | 0.0% | 10.0% | 10.0% | 10.0% | 10.0% | 10.0% | 10.0% | 0.0% |
| Single Bioflavonoid | 0.0% | 0.0% | 0.0% | 0.0% | 0.0% | 0.0% | 0.6% | 0.0% |

All ingredient quantities are quoted as wt % of the total composition, and relate to undiluted individual ingredients, except for:
lactic acid, which is an 80 wt % aqueous solution of L(+) lactic acid sold under the trade name Purac FCC80 or Purac Sanilac. The amount stated refers to the as-supplied material.
mixed bioflavonoids (hereinafter MBF) is a flavonoids-containing component containing including flavonols (eg. quercetin), flavonons (e.g. naringin, hesperidin) and/or flavons (e.g. rutin). The mixed bioflavonoids component contains 0.4% of said flavonoids. The amounts stated refers to the as-supplied material.
the betaine composition, which is a formulation of lauryl betaine, as a 30 wt % aqueous solution, for example available from McIntyre Group Limited under the trade mark MACKAM LAB. The amounts stated refer to the as-supplied material.
the single bioflavonoid selected for testing contains about 50 wt % of naringin and is hereinafter called SBF. The amount stated refers to the as-supplied material.

Citric, malic, lactic acid, MBF and SBF all readily commercially available.

Some of these materials are used in later examples and the same information applies.

### Example 1b

### Treatment Compositions

In order to carry out comparative tests using the concentrate compositions described in Example 1a, each of them was diluted with water to give a treatment composition, as a 2 wt % aqueous solution of each concentrate composition.

### Example 1c

### Microbial Testing

Each of the treatment compositions was subject to microbial tests to establish its antimicrobial efficacy.

As previously mentioned, the protocols employed for such testing are in accordance with BS EN 1276:1997, which describes how samples and assays are prepared as well as how bactericidal activities (or by extrapolation other antimicrobial activities) are calculated. A brief summary of these protocols is outlined below.

A sanitising composition is described by BS EN 1276:1997 as possessing bactericidal activity in respect of chemical disinfectant and antiseptic products for use in food, industrial, domestic and institutional areas, excluding areas and situations where disinfection is medically indicated and excluding products used on living tissues except those for hand hygiene, when the composition produces at least a 10⁵ reduction in the number of viable bacterial cells belonging to reference strains of Pseudomonas aeruginosa, Escherichia coli, Staphylococcus aureus and Enterococcus hirae.

A test suspension of the microorganism under test is added to a prepared sample of each treatment composition A-H. The mixture is maintained at 20° C.+/−1° C. for 5 min.+/−10 sec. The samples are then subject to membrane filtration, and the number of surviving microorganism colonies are then determined and the reduction in viable counts is calculated.

More details of the testing protocols are available in the document BS EN 1276:1997, issued on 17 Sep. 2002. Also outlined therein are the calculations necessary to ascertain the reduction in the number of viable bacterial cells, and hence whether a sample passes or fails the activity test. Under this test protocol a sample is deemed to fail an assay where the reduction is less than 10⁵.

In this particular example the test treatment compositions were tested against Pseudomonas aeruginosa ATCC 15442, Escherichia coli ATCC 10536, Staphylococcus aureus ATCC 6538, Enterococcus hirae ATCC 10541 and Salmonella typhimurium ATCC 13311.

The table below details the “log kill” of these bacteria. Log kill is defined as the logᵢₙ of the reduction in number of viable cells, by the test protocol described above. The symbols A-H here denote the diluted treatment compositions, as opposed to the concentrate compositions of Example 1a.

| | A | B | C | D | E | F | G | H |
|---|---|---|---|---|---|---|---|---|
| Pseudomonas aeruginosa | 1.7 | 2.7 | 2.4 | 7.8 | 7.8 | 7.1 | 3.2 | 5.5 |
| Staphylococcus aureus | 0.5 | 1.9 | 2.6 | 2.1 | 7.3 | 7.5 | 3.7 | 0.5 |
| Escherichia coli | 1.7 | 2.2 | 2.5 | 6.0 | 6.7 | 6.7 | 4.5 | 5.6 |
| Enterococcus hirae | 0.5 | 1.9 | 2.3 | 2.0 | 6.6 | 6.6 | 3.5 | 0.7 |
| Salmonella typhimurium | 2.0 | 3.6 | 2.7 | 6.1 | 7.1 | 7.1 | 4.9 | 5.7 |
| Average kill | 1.3 | 2.5 | 2.5 | 4.8 | 7.0 | 7.0 | 4.0 | 3.6 |

The results show significant improvement when the single bioflavonoid material is used with betaine surfactant and organic acid(s), but suggest that especially good performance is achieved when mixed bioflavonoids, betaine surfactant and organic acid(s) are present.

### Example 2

Composition F of Example 1 was also tested at dilutions of 1 wt % and 0.5 wt % in aqueous solution. Both samples passed the antimicrobial activity tests, suggesting that high dilutions may be suitable.

Composition F represents a preferred embodiment of the present invention, and has a number of advantages over the prior art. The first advantage is that the sanitising composition is highly effective and yet relatively mild so as to not damage the products to be sanitised. Furthermore, such compositions are effectively non-toxic, and as such the rinsing requirement following sanitisation of food products is much reduced. Such a rinsing requirement is further reduced owing to the effectiveness of these compositions at high dilution.

The inclusion of the surfactant also increases the efficacy of the flavonoids present, and as such less flavonoids are required. This in turn is more cost-effective and also beneficial during manufacture of the sanitising compositions. Furthermore the option to use such compositions at high dilutions also alleviates possible precipitation of certain components which in turn would compromise the reliability of such sanitising compositions.

### Example 3

The following concentrate composition was prepared using ingredients, in the manner described, above.

| | |
|---|---|
| Water | 69% |
| Citric acid | 5% |
| Malic acid | 10% |
| Lactic acid | 4% |
| MBF | 2% |
| Betaine composition | 10% |

This was diluted to a concentration of 2 wt % in water to form a treatment composition of pH in the range 2.1-2.6, and was tested using the protocols of BS EN 1276:1997 against a wider range of microbes, as follows:

| | Challenge | Survivors | % | Log |
|---|---|---|---|---|
| Culture | (cfu/ml) | (cfu/ml) | kill | kill |
| Pseudomonas aeruginosa | 1.1E+07 | 1.5E+01 | >99.999 | 5.9 |
| ATCC 15442 | | | | |
| Escherichia coli | 4.1E+07 | 0.0E+00 | >99.999 | >7.6 |
| ATCC 10536 | | | | |
| Staphylococcus aureus | 1.1E+07 | 6.0E+00 | >99.999 | 6.3 |
| ATCC 6538 | | | | |
| Enterococcus hirae | 2.0E+07 | 2.0E+00 | >99.999 | 7.0 |
| ATCC 10541 | | | | |
| Salmonella typhimurium | 3.4E+07 | 0.0E+00 | >99.999 | >7.5 |
| ATCC 13311 | | | | |
| Lactobacillus brevis | 3.4E+07 | 0.0E+00 | >99.999 | >7.5 |
| DSM 6225 | | | | |
| Enterobacter cloacae | 5.3E+07 | 3.8E+00 | >99.999 | 6.1 |
| DSM 6234 | | | | |
| Listeria monocytogenes | 4.2E+07 | 3.0E+00 | >99.999 | 7.1 |
| (lab strain) | | | | |
| Bacillus cereus | 2.7E+07 | 2.8E+00 | >99.999 | 6.0 |
| NCIMB 11925 | | | | |
| Campylobacter Jejuni | 4.6E+07 | 9.0E+00 | >99.999 | 6.7 |
| NCTC 11322 | | | | |
| Candida albicans | 5.2E+07 | 9.4E+00 | >99.999 | 5.7 |
| NCYC 1363 | | | | |
| Aspergillus niger | 1.2E+07 | 8.2E+00 | >99.999 | 5.2 |
| IMI 044215 | | | | |

### Example 4

A concentrate composition was prepared and diluted for testing in accordance with BS EN 1276, as described above in Example 1.

The concentrate composition was as follows:

| | |
|---|---|
| Water | 77% |
| Citric acid | 10% |
| Malic acid | 5% |
| Lactic acid | 4% |
| MBF | 2% |
| Polysorbate 65 | 2% |

The concentrate composition was diluted to a concentration of 2 wt % in water to yield a treatment composition of pH ˜2.1-2.6.

The test results are as follows:

| | Challenge | Survivors | % | Log |
|---|---|---|---|---|
| Culture | (cfu/ml) | (cfu/ml) | kill | kill |
| Pseudomonas aeruginosa | 3.7E+07 | 9.3E+01 | >99.999 | 5.6 |
| ATCC 15442 | | | | |
| Escherichia coli | 1.9E+07 | 8.0E+01 | >99.999 | 5.4 |
| ATCC 10536 | | | | |
| Staphylococcus aureus | 3.9E+07 | 3.3E+02 | >99.999 | 5.1 |
| ATCC 6538 | | | | |
| Enterococcus hirae | 3.0E+07 | 1.9E+02 | >99.999 | 5.2 |
| ATCC 10541 | | | | |
| Salmonella typhimurium | 1.3E+07 | 1.1E+02 | >99.999 | 5.1 |
| ATCC 13311 | | | | |
| Listeria monocytogenes | 1.7E+07 | 6.7E+01 | >99.999 | 5.4 |
| (Lab strain) | | | | |
| Bacillus cereus | 2.6E+07 | 3.1E+01 | >99.999 | 5.9 |
| NCIMB 11925 | | | | |
| Candida albicans | 3.3E+07 | 1.9E+02 | >99.999 | 5.2 |
| NCYC 1363 | | | | |
| Aspergillus niger | 2.1E+07 | 1.8E+02 | >99.999 | 5.1 |
| IMI 044215 | | | | |

### Comments

From consideration of the results presented here, it is believed that the following factors are of importance in respect of antimicrobial activity:
the quinone/phenol equilibrium within the bioflavonoids. This is believed to be a function of pH
microorganism cell wall penetration (believed to be influenced by the surfactant)
isoelectric point of the betaine surfactant, when used (the protonation state at various pHs). This is believed to be a function of pH
the presence of organic acid(s)
relative concentrations of ingredients
overall dilution.

1. A sanitising composition comprising:
at least one flavonoid; and
at least one surfactant;
wherein the composition is acidic.

2. A composition as claimed in any claim 1, being a concentrate which when diluted as a 2 wt % aqueous solution, gives a 10⁵ reduction in microbial colony count against at least one target microorganism whereas the same composition but without the surfactant, when diluted as a 2 wt % aqueous solution, gives a reduction of less than 10⁵ against the same target microorganism.

3. A composition as claimed in claim 2, wherein the pH of the composition, when diluted as a 2 wt % aqueous solution, is between 2 and 4, preferably between 2 and 3.

4. A composition as claimed in claim 1, comprising the flavonoid(s) is/are preferably selected from flavonols, flavonons and flavons.

5. A composition as claimed in claim 1 comprising from 0.001 to 10 wt % of flavonoid(s).

6. A composition as claimed in claim 1, further comprising at least one organic acid selected from ascorbic acid, citric acid, lactic acid and malic acid.

7. A composition as claimed in claim 1, wherein the surfactant comprises between 0.1 and 20 wt % of the total composition.

8. A composition as claimed in a claim 1, wherein the surfactant comprises a betaine surfactant.

9. A composition as claimed in claim 1, wherein the betaine surfactant has the general structure: 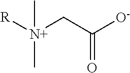
where R is an optionally substituted, branched or unbranched, alkyl group having from 4 to 24 carbon atoms.

10. A composition as claimed in claim 1, wherein the surfactant comprises a Polysorbate, for example Polysorbate 65.

11. A method of manufacturing the composition according to claim 1, comprising:
a) acidifying the solvent
b) blending the surfactant(s) and the flavonoid(s) with a solvent;
preferably with the flavonoid(s) being under acidic conditions throughout the method.

12. A ready-to-use treatment composition comprising water, at least one flavonoid; and at least one a surfactant; wherein the treatment composition is acidic.

13. A method of preparing the ready-to-use treatment composition as claimed in claim 12, comprising dissolving the sanitising composition as defined above in water.

14. A method of combating microorganisms at a locus, comprising delivering the composition as claimed in claim 1 to the locus or the vicinity thereof.

15. A method as claimed in claim 14, wherein the microorganisms to be combated include one or more of: Pseudomonas aeruginosa, Escherichia coli, Staphylococcus aureus, Enterococcus hirae.

16. A method as claimed in claim 14, wherein the microorganisms to be combated include one or more of: Pseudomonas, S. Aureus, MRSA, Clostridia, C. difficile.

17. A method as claimed in claim 14 wherein the microorganisms to be combated include one or more of: Salmonella typhimurium, Lactobacillus brevis, Enterobacter cloacae, Listeria monocytogenes, Bacillus cereus, Campylobacter Jejuni, Candida albicans, Aspergillus niger.

18. A sanitised food, medicine or laundry product comprising a food, medical or laundry product that has been sanitised through treatment with a sanitising composition or treatment composition of claim 1.

19. Use of the composition of claim 1, for decontaminating surfaces.

20. Use of the sanitising composition of claim 1, for washing food.
